(19) United States
(12) Patent Application Publication
(10) Pub. No.: US 2003/0195955 A1
(43) Pub. Date: Oct. 16, 2003

(54) Method and system for selecting a cluster owner based on one or more risk factors of the candidates

(76) Inventors: Robert A. Cochran, Roseville, CA (US); Richard S. Wilkins, Redmond, WA (US)

Correspondence Address: HEWLETT-PACKARD COMPANY, Intellectual Property Administration, P.O. Box 272400, Fort Collins, CO, 80527-2400, US

(21) Appl. No.: 10/121,546

(22) Filed: Apr. 12, 2002

(51) Int. Cl. G06F 15/173

(52) U.S. Cl. 709/223

(57) ABSTRACT

Method and system for selecting a new cluster owner for a cluster. The cluster includes a plurality of nodes, where one of the nodes is a current owner of the cluster. First, a determination is made that a new cluster owner is needed. Next, a list of candidates is received. A risk dependent owner selection mechanism selects a new cluster owner from the list of candidates based on at least one risk factor of the candidates.

### BACKGROUND OF THE INVENTION

Redundancy of data and host computers is the standard method employed to ensure the continued availability of a companies data and data processing ability.

A method of protecting data from catastrophic hard disk failure, which is known as disc mirroring, involves making a “mirror” copy on a second hard disk or a different part of the same disk as each file is stored on the first hard disk.

An approach to safeguarding the loss or damage to data processing ability is the use of high availability computer clusters. High availability computer clusters typically include a plurality of host computer nodes that are spread out across a geographic distance. This configuration allows for the survivability of the cluster in the event of a disaster that has a limited destruction radius. The cluster has a cluster owner computer node, which retains exclusive rights to performs certain operations for the cluster. These operations can include adding nodes to the cluster, dropping nodes from the cluster, and assigning disk ownership to specific nodes, as well as, defending any challenges from other nodes to usurp the title of cluster owner. The cluster owner remains so until the cluster owner fails or ownership designation is explicitly moved to another computer.

In a healthy cluster, all computer nodes are inter-communicating and are running their assigned parts of a user application(s). If the current cluster owner becomes non-communicative for any reason, the other nodes compete for the role of new cluster owner. The prior art succession methods use a first come, first served basis. For example, when one node fails for whatever reason, the prior art succession algorithms receive claims from different nodes in the cluster and pick a new “Cluster Owner” by determining the first node to claim the title. Once this title is claimed, the cluster owner controls all cluster operations.

A dangerous situation that can occur is called “split brain” syndrome. The “split brain” syndrome can be described as the situation where the old cluster owner is not down, but is just unable to communicate. The inability to communicate can be due to a temporary communications link failure. In this case, any other node that claims to be the new cluster owner and starts modifying data can unknowingly compete with the old cluster owner's data modifications, thereby causing data corruption. One approach to avoid the Split Brain syndrome is for all nodes to agree that a neutral “Third Party Arbiter” (TPA) has the final say. Before the TPA allows the cluster to reform under a new owner, the TPA first ensures that the old owner has been shutdown or has been destroyed. Once the TPA has determined that the old cluster owner is no longer operational, the TPA typically selects a new cluster owner based solely on which node requested the title first.

FIG. 6 illustrates a prior art cluster owner succession method. In this example, the node that fails or is otherwise non-communicative is in a zone of destruction. Nodes N2, N3, N4 and N5 each respond with a request to be the new cluster owner. Unfortunately, node N2 is a poor candidate since node N2 may soon fail due to the hazard that caused node N1 to fail. In the event that node N2 also fails, node N3 is selected to be the next cluster owner, solely because node N3 responded earlier than node N4 and node N5.

It is noted that even if node N2 is slightly outside the zone of initial destruction, node N2 will not be a very good candidate since the zone of destruction cannot be confined, and the zone of destruction (e.g., a tornado or hurricane) can easily spread outwards and encompass the closest alternate cluster nodes.

Accordingly, it would be desirable for there to be a mechanism to gauge the likelihood of survivability of candidate nodes.

Based on the foregoing, there remains a need for a mechanism for selecting a new cluster owner that considers one or more risk factors of the candidates, and that overcomes the disadvantages set forth previously.

### SUMMARY OF THE INVENTION

According to one embodiment of the present invention, a method and system for selecting a new cluster owner for a cluster based on at least one risk factor of the candidates are described. The cluster includes a plurality of nodes, where one of the nodes is a current owner of the cluster. First, a determination is made that a new cluster owner is needed. Next, a list of candidates is received. A risk dependent owner selection mechanism selects a new cluster owner from the list of candidates based on at least one risk factor of the candidates.

According to another embodiment of the present invention, a mechanism (e.g., a third party arbiter) is provided for determining that a new cluster owner is needed. The mechanism includes a risk dependent owner selection mechanism for selecting a new cluster owner from a list of vying candidates based on one or more of the following: user input, current date, actuarial risk estimates by candidate location, and, operator bias input, and one or more risk factors of the candidates.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a system according to one embodiment of the present invention.

FIG. 2 illustrates in greater detail the third party arbiter (TPA) of FIG. 1 according to one embodiment of the present invention.

FIG. 3 illustrates in greater detail the cluster arbiter risk estimator (CARE) of FIG. 1 according to one embodiment of the present invention.

FIG. 4 is a flow chart illustrating the steps in selecting a new cluster owner in accordance with one embodiment of the present invention.

FIG. 5 is a flow chart illustrating the steps in selecting a new cluster owner in accordance with another embodiment of the present invention.

FIG. 6 illustrates a cluster that employs a prior art cluster owner succession method and the relative distances of cluster nodes in relationship to a failed cluster owner node.

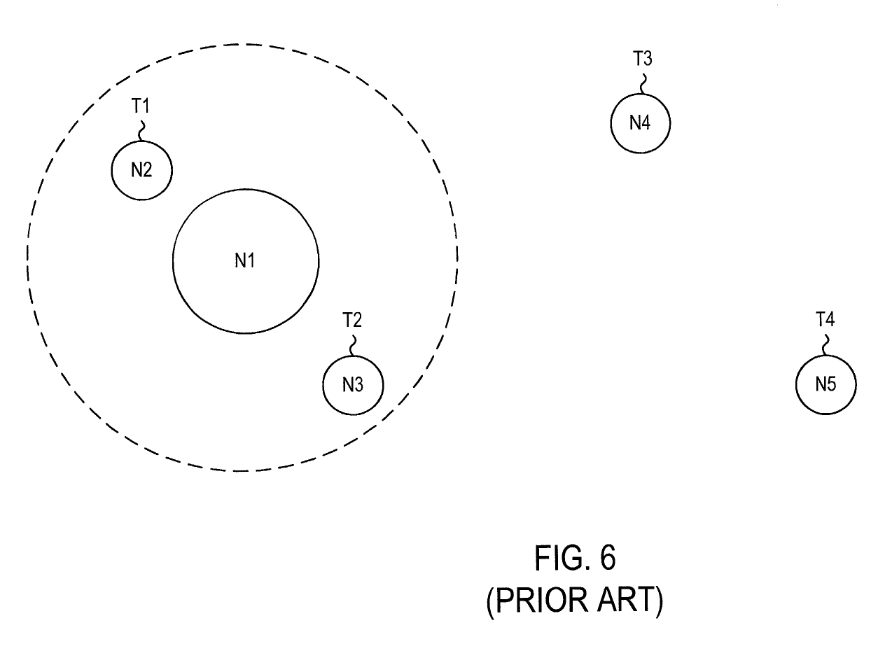

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

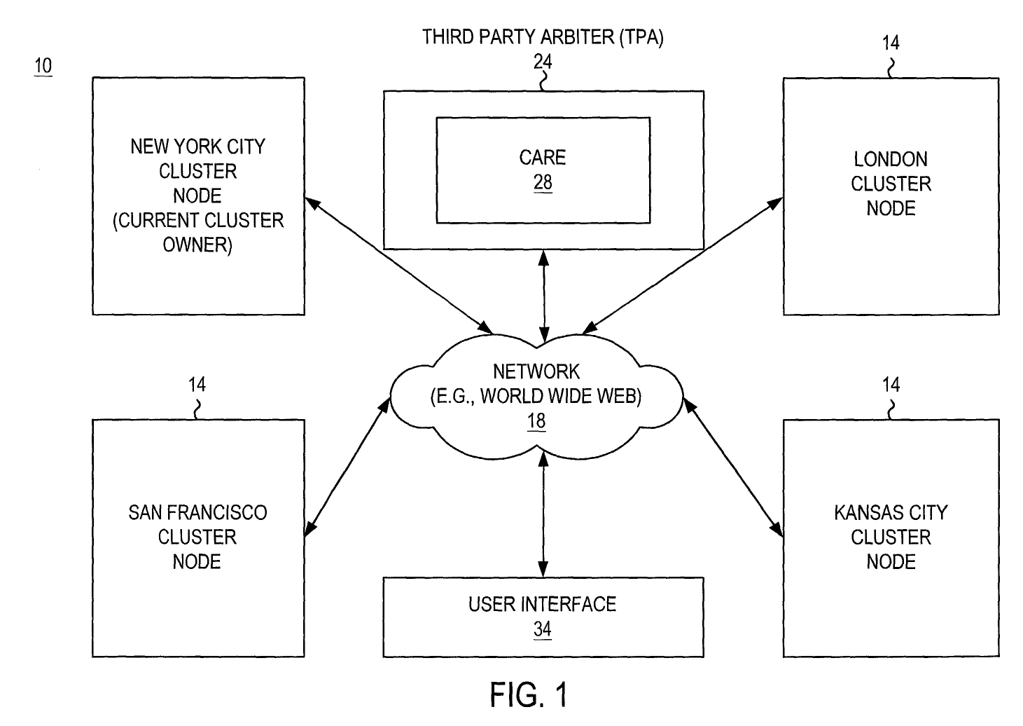

FIG. 1 illustrates a system 10 according to one embodiment of the present invention. The system 10 can be a geographically dispersed highly available computer cluster that includes a plurality of cluster nodes 14. In this example, the system 10 includes a New York City cluster node, a London cluster node, a San Francisco cluster node, and a Kansas City cluster node. The cluster nodes 14 communicate through a network 18, which can be a private WAN or the World Wide Web (WWW).

Each cluster node 14 is a computer that contains data or applications accessible by other users of the networked cluster 18. The cluster includes a set of cooperating application programs. Each node has access to, and operates on, a part of the shared cluster application data. The cluster owner is aware of the data portion owned by each node in the cluster, as well as the data processing mission or task of each node in the cluster. If any node fails, the current cluster owner re-appropriates the tasks and data of the failed node to each surviving node in order to cover the work of the failing node and to continue the non-stop nature of the cluster.

The system 10 also includes user interface module 34 for use by a user to input information (e.g., risk factors of each candidate). In one embodiment, the user interface module 34 is integrated with the CARE 28. In another embodiment, the user interface module 34 is implemented separate from the CARE 28.

User Interface Module 34

The user interface module 34 enables the cluster owner selection mechanism of the present invention to be accessed from anywhere through a World Wide Web (WWW) interface. The selection mechanism of the present invention includes a graphical user interface (GUI) that allows a user to create a node's risk profile in a convenient, easy-to-use, and efficient manner.

One of the cluster nodes is designated as the current cluster owner. In this case, the New York City cluster node is the current cluster owner. The cluster owner handles certain operations for the clusters. These operations include, but are not limited to, adding nodes to the cluster, dropping nodes from the cluster, assigning disk ownership and data processing tasks to specific nodes and defending any challenges from other nodes to usurp the title of cluster owner. The cluster owner remains the cluster owner, until the cluster owner fails or ownership is explicitly moved to another cluster node.

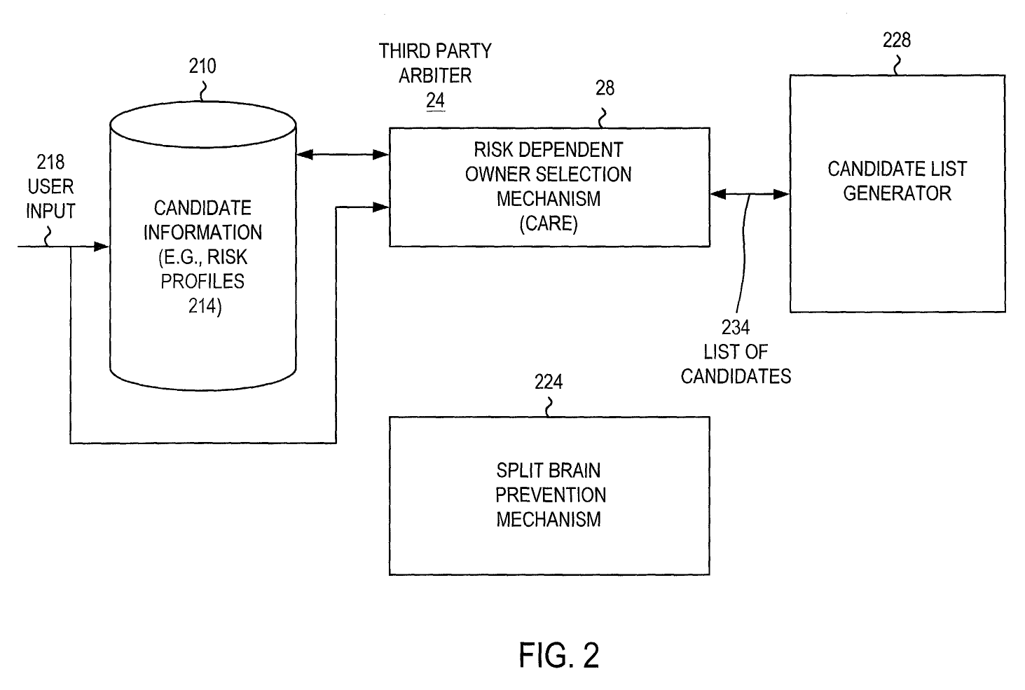

The system 10 also includes a neutral party 24 (e.g., a third party arbiter (TPA)). The third party arbiter 24 (TPA) is described in greater detail hereinafter with reference to FIG. 2.

The system 10 also includes a risk dependent owner selection mechanism (RDOSM) 28, which is also referred to herein as a cluster arbiter risk estimator (CARE).

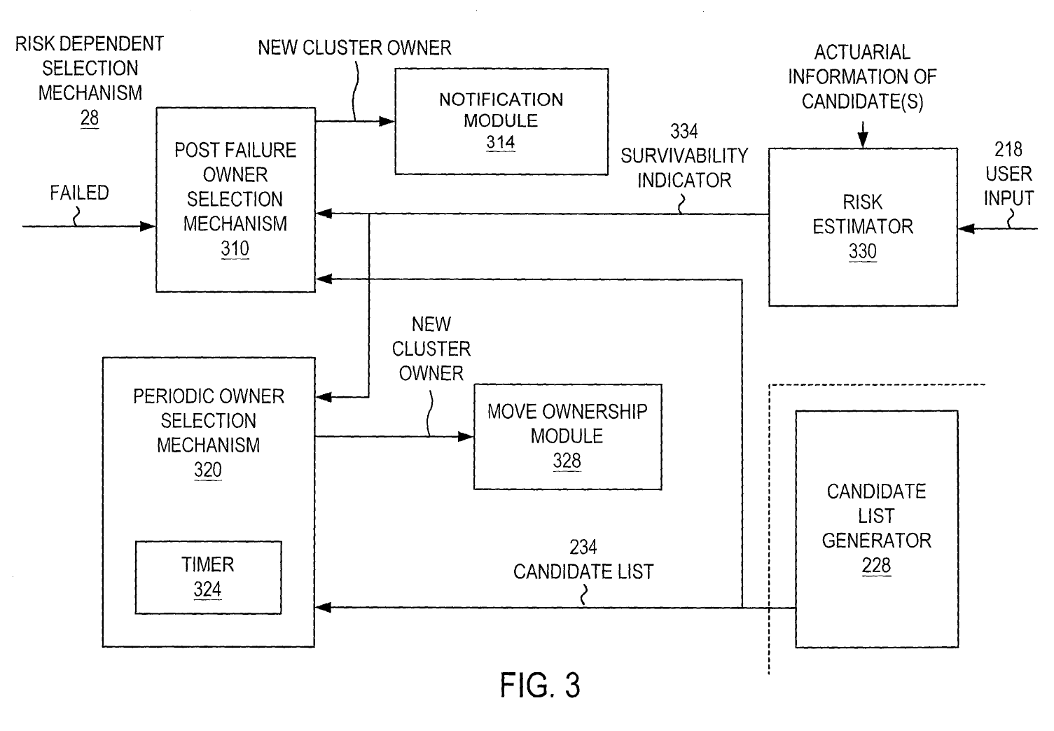

It is noted that the risk dependent owner selection mechanism (RDOSM) 28, which is described in greater detail hereinafter with reference to FIG. 3, may be implemented in the neutral party 28 as shown, in any of the cluster nodes 14, or in another device that is external to the cluster nodes.

Third Party Arbiter 24

FIG. 2 illustrates in greater detail the third party arbiter 24 (TPA) of FIG. 1 according to one embodiment of the present invention. The TPA 24 can include a database 210 for storing candidate information 214 (e.g., risk profiles of the candidates). As described in greater detail hereinafter, the candidate information 214 may be changed, modified, biased or otherwise updated by user input 218.

The TPA 24 can also include a candidate list generator 228 for generating a list of candidates 234 for the new cluster owner. The new owner is selected from the list of candidates 234 by the risk-dependent owner selection mechanism 28 of the present invention.

The TPA 24 can also include a split-brain prevention mechanism 224 for ensuring that a “split brain” situation does not occur after a new owner is selected. In the situation where an existing owner fails to respond to the TPA 24, the TPA 24 selects a new cluster owner. Should the prior owner ever reestablish communications with the TPA 24, the TPA 24 forces the Operating System of the prior owner to immediately halt operation, thereby preventing a “split brain” situation, where more than one node acts as a cluster owner.

Risk-Dependent Owner Selection Mechanism 28

FIG. 3 illustrates in greater detail the risk-dependent owner selection mechanism 28 of FIG. 1 according to one embodiment of the present invention. The risk-dependent owner selection mechanism 28 includes a first input for receiving actuarial information or data, a second input for receiving user input, a third input for receiving a list of currently vying candidates, a fourth input for receiving other candidate specific information (e.g., the location of the candidate), and a fifth input for receiving non-candidate specific information (e.g., the current date and time). As described in greater detail hereinafter, the user input can be information that is utilized to bias the risk profiles of the candidates based on current events.

In one embodiment, the location of each candidate and the current time are the inputs that are utilized to access the database.

Based on these inputs, the risk-dependent owner selection mechanism 28 of the present invention generates a new cluster owner by considering the risk profiles of each of the candidates.

The risk-dependent owner selection mechanism 28 includes a post-failure owner selection mechanism 310 for selecting a new cluster owner when the current cluster owner has failed and a periodic owner selection mechanism 320 for periodically selecting a new cluster owner after a predetermined time interval has elapsed.

The periodic owner selection mechanism 320 includes a timer 324 for tracking and determining when a predetermined time interval has elapsed. The periodic owner selection mechanism 320 also includes a move ownership module 328 for requesting that a current cluster owner to relinquish ownership rights to the cluster and for notifying the new cluster owner of its new status and responsibilities.

The post-failure owner selection mechanism 310 includes a notification module 314 for notifying a selected candidate that it is the new cluster owner.

The risk-dependent owner selection mechanism 28 also includes a risk estimator 330 for generating a survivability indicator 334 (e.g., a risk of failure or a probability that a candidate will survive) based on actuarial information of the candidate(s) and possibly user bias input 218. The survivability indicator 334 (e.g., the survivability indicator for each candidate) is provided to both the post-failure owner selection mechanism 310 and the periodic owner selection mechanism 320. The post-failure owner selection mechanism 310 and the periodic owner selection mechanism 320 select a new cluster owner based on the candidate list 234 provided by the candidate list generator 228 and at least one risk factor of one of the candidates. In one embodiment, the risk factor includes risk profiles of the candidates that may be in the form of actuarial information, probability of survivability (e.g., a survivability indicator 334 or a relative survivability index), or a risk of failure.

User input can include weather information, disaster information, a list of dates of previous terrorist attack, political activities (e.g., a national convention for one of the political parties) in the vicinity of a candidate, sporting activities (e.g., the Olympics, a national finals, or local game) in the vicinity of a candidate, reported terrorist threats (e.g., on a bridge or famous building or landmark) in the vicinity of a candidate.

It is noted that the location can be specified by city, state, zip code, street address, longitude and latitude, landmarks (e.g., famous buildings or other landmarks), coordinates (e.g., global positioning satellite coordinates).

In one embodiment, those candidates whose location is within a predetermined radius from a particular location or vicinity are skipped (i.e., these candidates have a high risk of failure and are not selected to be the next owner).

The database can include actuarial information from which the risk of failure or probability of survivability may be determined or derived.

Next Owner Selection Logic

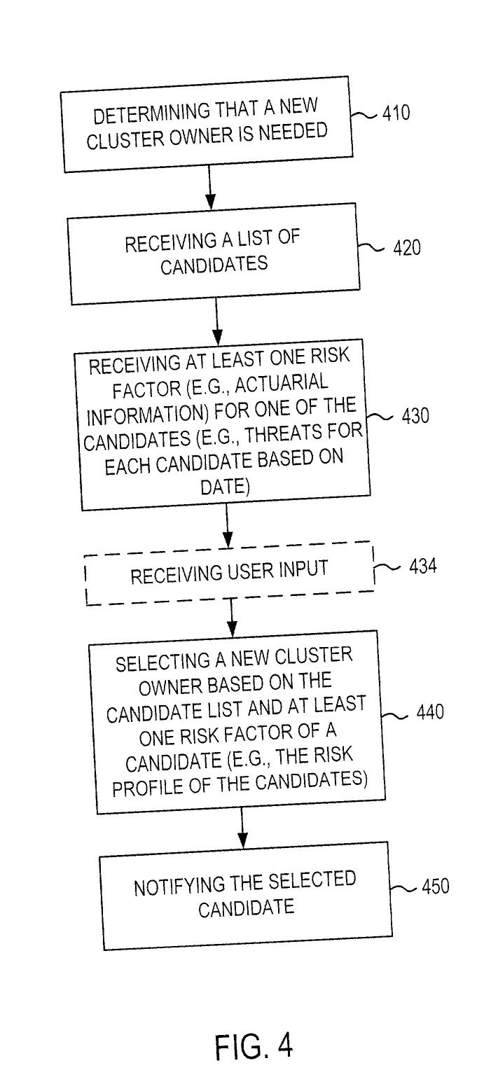

FIG. 4 is a flow chart illustrating the steps in selecting a new cluster owner in accordance with one embodiment of the present invention. In step 410, it is determined that a new cluster owner is needed. Step 410 can be performed by one of the cluster nodes 14 or by a neutral third party (e.g., by a third party arbiter 24). In step 420, a list of candidates is received. In step 430, at least one risk factor of the candidates (e.g., actuarial information about the candidates) is received. The risk factor can include, for example, location, current date, current time, actuarial information, current events, user input, or other factors. Step 420 can include the sub-step of accessing a database for actuarial information about the candidates.

Optionally, an additional step (step 434) of receiving user input is performed. The user input can be directly provided to the risk-dependent owner selection mechanism to modify, update, or bias the risk profile of one or more candidates according to current weather conditions, recent threats, etc.

In step 440, a new cluster owner is selected from the list of candidates based on at least one risk factor of the candidates. In one embodiment, the new cluster owner is chosen by selecting the candidate with the highest probability of survivability or the lowest risk of failure. The probability of survivability can be based on one or more of the following: actuarial information of the candidates (e.g., the risk profiles of the candidates), current events, the current date, the current time, the location of the cluster owner, and user input.

In step 450, the selected candidate is notified that it is the new cluster owner.

Pseudo code for the selection of a new owner based on actuarial information is now described.

if (arbiter (e.g., a third party arbiter (TPA)) is aware that a new

cluster owner is needed)

{
Wait a few seconds to get a list of nodes volunteering to be the new

Cluster Owner

Access actuarial information about the candidates (e.g., from a locally

resident Risk Profile database), based on one or more factors
(e.g., the date and time)

Select the node, which based on the factors (e.g., at this day and

time) is most likely to survive

Notify the preferred node that it is the new Cluster Owner
}

Periodic Owner Selection Logic

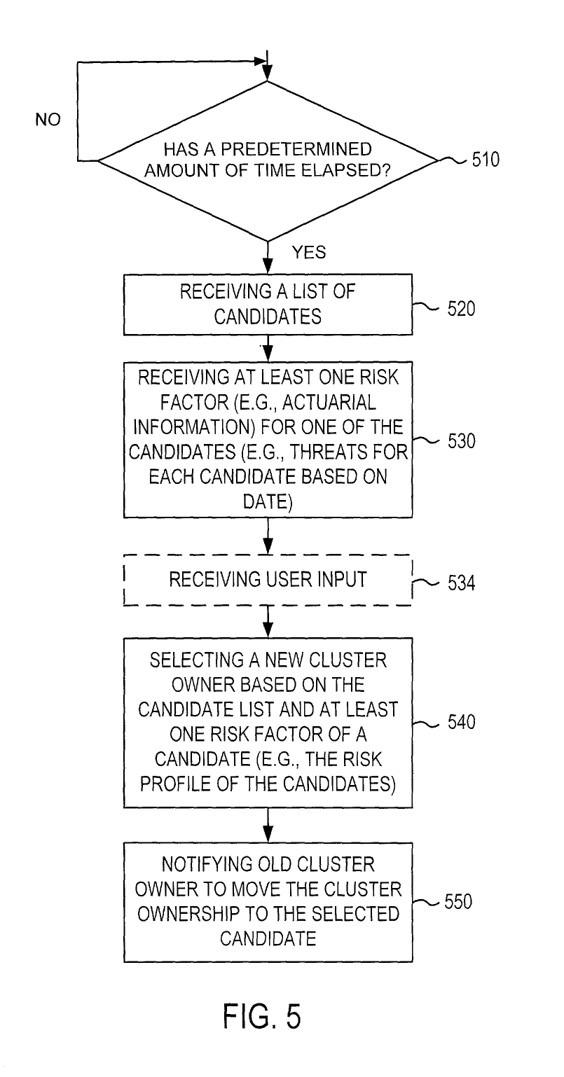

FIG. 5 is a flow chart illustrating the steps in selecting a new cluster owner in accordance with another embodiment of the present invention. In step 510, a determination is made whether a predetermined amount of time has elapsed since the last change in cluster ownership. When it is determined that a predetermined amount of time has not elapsed, the processing proceeds back to step 510.

When it is determined that a predetermined amount of time has elapsed, the processing proceeds to step 520. In step 520, a list of candidates is received. If the incumbent cluster owner is among the list of volunteer candidates, incumbent cluster owner is ignored for this instance of candidate selection.

In step 530, at least one risk factor of the candidates (e.g., actuarial information about the candidates) is received. The risk factor can include, for example, location, current date, current time, actuarial information, current events, user input, or other factors. Step 520 can include the sub-step of accessing a database for actuarial information about the candidates.

Optionally, an additional step (step 534) of receiving user input is performed. The user input can be directly provided to the risk-dependent owner selection mechanism to modify, update, or bias the risk profile of one or more candidates according to current weather conditions, recent threats, etc.

In step 540, a new cluster owner is selected from the list of candidates based on at least one risk factor of the candidates. In one embodiment, the new cluster owner is chosen by selecting the candidate with the highest probability of survivability or the lowest risk of failure. The probability of survivability can be based on one or more of the following: actuarial information of the candidates (e.g., the risk profiles of the candidates), current events, the current date, the current time, the location of the cluster owner, and user input.

In step 550, the old cluster owner is notified to move the cluster ownership to the selected candidate.

Pseudo code for periodic selection of a new owner based on actuarial information is now described.

if (time delay exceeded (e.g., once a day) {
Access actuarial information about the candidates (e.g., from a locally

resident Risk Profile database), based on one or more factors (e.g., the
date, time, etc.)

Select the node, which based on the factors (e.g., at this day and

time) is most likely to survive

If (new owner selected)

{
Notify the old Cluster Owner to relinquish ownership to the new

Owner

}

}

The risk dependent owner selection mechanism of the present invention recognizes and addresses the fact that geographically distributed nodes are not created equal, and geographically distributed nodes do not have a constant risk of disaster from day to day. The random selection of the cluster owner by prior art approaches can result in a costly cluster disruption when the cluster owner or the new site, in cases of actual failures, is either within the destruction radius of whatever rendered the original cluster owner to be non-communicative, or is seasonally more prone to failure due to the day of the year.

According to one embodiment, the cluster arbiter risk estimator (C.A.R.E.) employs cluster-specific information (e.g., location information) or non-cluster specific information (e.g., date) against a database of known actuarial risks to select the candidate with the highest probability of survival or the least likely risk of failure to be the new cluster owner. The CARE can perform the selection periodically or in the event of a failure of the current cluster owner, where multiple alternate sites are vying for cluster ownership.

In another embodiment, the risk profiles may be changed, updated or otherwise modified by an operator. For example, an operator can input information to account for temporary threats (e.g., a terrorist threat on a suspension bridge, earthquake warnings, flood warnings, fire warnings, tornado warnings, hurricane warnings, etc). In this manner, the CARE can reduce costly cluster/application downtime as compared to a random selection of the new cluster owner, which may also be at risk. In one example, the city of Kansas may typically be a safe location, except during the spring flood and tornado season.

In highly competitive applications (e.g., financial transactions and stock trading), the downtime (e.g., 10 minutes) associated with each cluster ownership change and application restart, can cost more than $100,000 per minute. In this regard, the use of the selection mechanism of the present invention can provide a competitive advantage and significant cost savings.

TABLES I and II illustrate exemplary spreadsheets that record the risk profiles for the Kansas City cluster node and the San Francisco cluster node, respectively.

TABLES I and II illustrate how a geographic site's risk profile is anything but constant. It is noted that each of the many possible causes of a site disruption vary in likelihood based on a number of different factors, such as, but not limited to, the season, date, and current events.

For instance, Kansas City shows a much higher risk than San Francisco during the spring flood and tornado season, but is normally a lower risk at other times of the year. Also, it is noted that in November, San Francisco would normally be a slightly lower risk than Kansas City, except when an operator has noted a temporary terrorist threat against a nearby suspension bridge. Consequently, CARE takes into account the reality that risk profiles are not static, and gives the user a measurably improved best chance that the node selected to be the cluster owner will survive and remain in service.

The temporary threat column may be populated with user input about current threats (e.g., news headlines, current activities or events in the vicinity of the cluster node, etc.).

TABLE I

| Kansas City | Jan | Feb | Mar | Apr | May | Jun | Jul | Aug | Sep | Oct | Nov | Dec |
|---|---|---|---|---|---|---|---|---|---|---|---|---|
| Fire-lightning | 1 | 1 | 1 | 4 | 9 | 15 | 22 | 15 | 4 | 1 | 1 | 1 |
| Fire-civil | 1 | 1 | 1 | 1 | 1 | 1 | 1 | 1 | 1 | 1 | 5 | 1 |
| unrest | | | | | | | | | | | | |
| Fire-forest | 1 | 1 | 1 | 1 | 1 | 1 | 1 | 1 | 1 | 1 | 1 | 1 |
| Flood-flood | 1 | 5 | 11 | 19 | 11 | 5 | 1 | 1 | 1 | 1 | 6 | 1 |
| plain | | | | | | | | | | | | |
| Flood-Below | 3 | 1 | 1 | 1 | 1 | 1 | 1 | 1 | 1 | 1 | 3 | 3 |
| Dam | | | | | | | | | | | | |
| Hurricane | 0 | 0 | 0 | 0 | 0 | 0 | 0 | 0 | 0 | 0 | 0 | 0 |
| Tornado | 1 | 1 | 1 | 11 | 15 | 18 | 20 | 22 | 15 | 5 | 1 | 1 |
| Disruptive | 1 | 1 | 11 | 12 | 15 | 3 | 4 | 5 | 9 | 5 | 1 | 1 |
| rain/snow | | | | | | | | | | | | |
| Active Earthquake | 1 | 1 | 1 | 1 | 1 | 1 | 1 | 1 | 1 | 1 | 1 | 1 |
| Fault proximity | | | | | | | | | | | | |
| Temp Threat | 0 | 0 | 0 | 0 | 0 | 0 | 0 | 0 | 0 | 0 | 0 | 0 |
| Metro/Strategic Target | 5 | 5 | 5 | 5 | 5 | 5 | 5 | 5 | 5 | 5 | 5 | 8 |
| Proximity | | | | | | | | | | | | |
| Total | 15 | 17 | 33 | 55 | 59 | 50 | 56 | 52 | 38 | 21 | 24 | 18 |

TABLE II

| San Francisco | Jan | Feb | Mar | Apr | May | Jun | Jul | Aug | Sep | Oct | Nov | Dec |
|---|---|---|---|---|---|---|---|---|---|---|---|---|
| Fire-lightning | 0 | 0 | 0 | 1 | 2 | 3 | 4 | 4 | 2 | 1 | 0 | 0 |
| Fire-civil unrest | 3 | 3 | 3 | 3 | 3 | 3 | 3 | 3 | 3 | 3 | 3 | 3 |
| Fire-forest | 1 | 1 | 1 | 1 | 1 | 1 | 1 | 1 | 1 | 1 | 1 | 1 |
| Flood-floodplain | 1 | 1 | 1 | 1 | 1 | 1 | 1 | 1 | 1 | 1 | 1 | 1 |
| Flood-Below Dam | 1 | 1 | 1 | 1 | 1 | 1 | 1 | 1 | 1 | 1 | 1 | 1 |
| Hurricane | 0 | 0 | 0 | 0 | 0 | 0 | 0 | 0 | 0 | 0 | 0 | 0 |
| Tornado | 0 | 0 | 0 | 0 | 0 | 0 | 0 | 1 | 2 | 2 | 1 | 0 |
| Disruptive | 1 | 1 | 8 | 9 | 8 | 2 | 1 | 1 | 1 | 1 | 1 | 1 |
| rain/snow | | | | | | | | | | | | |
| Active Earthquake | 9 | 9 | 9 | 9 | 9 | 9 | 9 | 9 | 9 | 9 | 9 | 9 |
| Fault proximity | | | | | | | | | | | | |
| Temp Threat | 0 | 0 | 0 | 0 | 0 | 0 | 0 | 0 | 0 | 0 | 20 | 0 |
| Metro/Strategic | 5 | 5 | 5 | 5 | 5 | 5 | 5 | 5 | 5 | 5 | 5 | 8 |
| Target Proximity | | | | | | | | | | | | |
| Total | 21 | 21 | 28 | 30 | 30 | 25 | 25 | 26 | 25 | 24 | 42 | 24 |

In one embodiment, the selection mechanism of the present invention is implemented in a third party arbiter (TPA). The third party arbiter (TPA) can be implemented with a computer (e.g., a personal computer PC) that is equipped with communication interface for communicating with the other nodes and an interface for communicating with the database that stores the risk profiles of the cluster nodes.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for selecting a new cluster owner comprising the steps of:
a) determining that a new cluster owner is needed;
b) receiving a list of candidates; and
c) selecting a new cluster owner from a list of candidates based on at least one risk factor of the candidates.

2. The method of claim 1 wherein the risk factor includes one of location, current date, current time, actuarial information, current events, user input, and other factors.

3. The method of claim 1 wherein the step of selecting a new cluster owner from a list of candidates based on at least one risk factor of the candidates includes
retrieving the risk factor of the candidates from a database; and
using the risk factor in the selection process.

4. The method of claim 1 wherein each candidate is associated with a risk profile that includes the risk factors of the candidate; wherein the step of selecting a new cluster owner from a list of candidates based on at least one risk factor of the candidates includes the step of
selecting a new cluster owner based on a current date and the risk profile of the candidates.

5. The method of claim 1 wherein the method for selecting a new cluster owner is implemented in a third party arbiter (TPA).

6. The method of claim 1 further comprising the step of:
selecting a new cluster owner from the list of candidates; wherein the candidate with one of the lowest risk of failure and the highest probability of survival is selected.

7. The method of claim 1 further comprising the step of:
notifying the current cluster owner to relinquish cluster ownership; and
notifying the selected candidate that the selected candidate is the new cluster owner.

8. The method of claim 1 wherein the step of selecting a new cluster owner from a list of candidates based on at least one risk factor of the candidates further comprises the step of:
preventing a split brain scenario in the selection of a new cluster owner.

9. The method of claim 8 further wherein the step of preventing a split brain scenario in the selection of a new cluster owner includes one of
employing a third-party arbiter; and
preventing the cluster from re-starting when a split brain scenario is a possibility.

10. The method of claim 1 further wherein the risk factor include one of
seasonal threats; natural threats; man-made threats; permanent threats; and temporary threats.

11. The method of claim 10 further wherein natural threats includes one of tornado threat, hurricane threat, below-dam flood threat, floodplain flood threat, forest fire threat, civil unrest fire threat, lighting fire threat, earthquake fault proximity threat, disruptive rainfall/snow threat, and strategic target proximity threat.

12. The method of claim 10 further wherein man-made includes one of civil unrest threat, arson threat, and terrorist threat.

13. The method of claim 1 further comprising:
modifying at least one of risk factor; and
determining a new cluster owner based on the modified risk factor.

14. The method of claim 1 wherein steps (b) and (c) are repeated periodically after a predetermined time interval.

15. The method of claim 1 wherein steps (b) and (c) are repeated in the event of failure of the current cluster owner.

16. The method of claim 14 wherein each candidate is associated with a risk profile that includes the risk factors of the candidate; and wherein the risk profile of each candidate is stored in database; and wherein the risk profile indicates the relative survivability index of the candidate based on one or more inputs.

17. A system for selecting a new cluster owner comprising:
a) a cluster of nodes;
b) a current owner of the cluster;
c) a risk dependent owner selection mechanism for selecting a new cluster owner from a list of candidates based on at least one risk factor of the candidates.

18. The system of claim 17 wherein the risk factor includes one of location, current date, current time, actuarial information, current events, user input, predicted survivability, risk of failure, and other factors.

19. The system of claim 17 wherein each candidate is associated with a risk profile that includes the risk factors of the candidate; wherein the risk dependent owner selection mechanism selects a new cluster owner based on a current date and the risk profile of the candidates.

20. The system of claim 17 further comprising:
d) a third party arbiter for determining that a new cluster owner is needed;
wherein the risk dependent owner selection mechanism is implemented in the third party arbiter.
